(19) United States
(12) Patent Application Publication
(10) Pub. No.: US 2025/0307665 A1
(43) Pub. Date: Oct. 2, 2025

(54) DYNAMIC CONTENT GENERATOR

(71) Applicant: BOLD Limited, Hamilton (BM)

(72) Inventors: Sarah MCCAFFERTY, San Francisco, CA (US); Shikha RANI, Noida (IN); Abhishek Kumar SINGH, Noida (IN); Ankur MAURYA, Ayodhya (IN); Vandana SINGH, Noida (IN)

(21) Appl. No.: 18/622,747

(22) Filed: Mar. 29, 2024

(51) Int. Cl. G06N 5/022; G06Q 10/105

(52) U.S. Cl. CPC G06N 5/022; G06Q 10/105

(57) ABSTRACT

The disclosure provides methods and systems for dynamic content generation. A method may receive, at a first interactive element of a user interface, at least one job title. The method may receive, at a second interactive element of the user interface, a template selection from a list of available templates representing a graphical design for the sample résumé. The method may generate a prompt including the at least one job title. The method may provide the prompt to an artificial intelligence (AI) model instructing the AI model to generate content related to the at least one job title included in the prompt. The method may receive résumé content generated by the AI model based on the prompt. The method may apply the template selection to the résumé content to generate the sample résumé. Furthermore, the method may display the sample résumé in a third interactive element of the user interface.

### BACKGROUND

### Field

Aspects of the present disclosure relate to content generation, and more particularly, to a dynamic content generator.

### Description of Related Art

Content developers are often employed by web-based companies to increase engagement by potential customers. Some companies may choose to provide content (e.g., assets) such as articles of interest to the company's target demographic. Other companies may provide content showcasing their product or service offerings. It is well-known that individuals (e.g., potential customers) return to websites that periodically provide new, compelling content. Thus, in order to increase attention from search engines, that in turn increases visits, both of new viewers and returning viewers, new and relevant content needs to be provided often, (e.g., daily or weekly). Additionally, the content needs to remain relevant and engaging. However, development of new, engaging and relevant content can be time consuming and costly.

### SUMMARY

In one general aspect, a method may include receiving, at a first interactive element of a user interface, at least one job title. The method may also include receiving, at a second interactive element of the user interface, a template selection from a list of available templates, each template in the list of available templates represents a graphical design of an output for the sample résumé. The method may furthermore include generating a prompt including the at least one job title. The method may in addition include providing the prompt to an artificial intelligence (AI) model instructing the AI model to generate content related to the at least one job title included in the prompt. The method may moreover include receiving résumé content generated by the AI model based on the prompt. The method may also include applying the template selection to the résumé content to generate the sample résumé. The method may furthermore include displaying the sample résumé in a third interactive element of the user interface.

In one general aspect, a method may include receiving, at the résumé creation system, at least one job title from a user interface. The method may also include generating, by the résumé creation system, a prompt including the at least one job title, the prompt being configured to cause an artificial intelligence (AI) model to generate content associated with a résumé. The method may, furthermore, include receiving, at the résumé creation system, a template selection from a list of available templates displayed in the user interface, each template in the list of available templates represents a graphical design of an output for the sample résumé. The method may, in addition, include receiving, at the résumé creation system, résumé content generated by the AI model based on the prompt. The method may, moreover, include applying, by the résumé creation system, the template selection to the résumé content to generate the sample résumé. The method may also include displaying, in an interactive element of the user interface, the sample résumé, the interactive element being configured to accept edits to the résumé content of the sample résumé.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a user interface implementing aspects of the present disclosure.

FIG. 2 depicts a block representation of a process implementing aspects of the present disclosure.

FIG. 3 depicts a method implementing aspects of the present disclosure.

FIG. 4 depicts another method implementing aspects of the present disclosure.

FIG. 5 depicts a processing system capable of implementing aspects of the present disclosure.

FIG. 6 depicts an example prompt template in accordance with aspects of the present disclosure.

FIGS. 7-12 depict another user interface configured to implement aspects of the present disclosure at various stages of use.

FIG. 13 depicts an example CSV file used to provide bulk content generation in accordance with aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating content, such as content for websites. Content is often used to drive visits to websites, such as by increasing website relevance to a search engine, for the purposes of increasing utilization of the services, or sale of products offered by the website owner. Such content may include, for example, articles, blog posts, how-to guides directed to using the products and services offered, and in cases where companies create certain types of content (e.g., resumes, cover letters, job postings, etc.) example of those content types, as well as examples created with the products or services, and the like. Additionally, the frequency with which new content is added (e.g., the content refresh rate) influences the traffic generated to the website. In the context of the present disclosure, traffic refers to the number of individuals that visit a website in a given time period. High traffic can often translate to increased sales, thus companies are continually searching for ways to increase traffic.

Additionally, the content may be presented during an individual's search of a particular topic. For example, an individual looking for job postings in a particular field may search for a job title such as “sales representative.” Companies that offer employment related services, such as résumé creation services, or job listing services, may appear as relevant in the search results by utilizing search engine optimization (SEO) and search engine marketing (SEM) techniques. Having content to present in a search result that is appealing and tailored to the searcher increases the likelihood that the individual will visit the website and perhaps purchase offered products and services.

In the field of résumé creation services, for example, presenting an individual searching for jobs relating to “sales representative” with example résumés tailored to that job title may lead the individual to proceed to the résumé creation service website. In fact, providing a highly relevant résumé as an example is more likely to attract an individual to visit the website than a generic résumé. This applies to other types of content as well. However, in order to provide tailored content with the current state of the art according to prior approaches, content creators need to create numerous versions of the content manually, which is time consuming and expensive, and which ultimately relies on the intrinsic talent of the human content creators.

Turning back to the résumé example, example resumes would need to be created for a large number of job titles, experience levels, and designs in order to showcase the résumé creation tools. Creating such a large number of résumés, or content in general, can be time consuming and expensive. Further, the style, quality, etc. of the content created by human content creators may vary in meaningful ways that leads to inconsistent “look and feel” of the content used to solicit potential users of an online service.

Aspects of the present disclosure provide techniques for integrating AI tools into a content creation workflow in order to reduce production time and cost, and to increase quality, consistency, and diversity of content. In particular, aspects of the present disclosure provide customized prompts for a target AI model, such as a large language model (LLM), which causes the AI model to generate raw content satisfying one or more criteria related to the desired output. Thus, for example, for résumé content, the prompt may provide instructions for the AI model to create a name, a defined number of previous jobs direct to a particular job title, related skills matching a given experience level, and an education appropriate for the job history. Moreover the prompt may instruct the AI model to output the content in a particular format that can be easily imported into content authoring tools. Thus, certain aspects of the present disclosure free content creators from having to create each sample résumé from scratch, instead the content creators can start from an AI-generated outline. In this way the content creators can focus their time on editing the generated content and enhancing the content with additional details.

Currently, content authoring, particularly authoring résumé content, can be a tedious and time consuming endeavor in which a content author creates content, such as articles or sample résumés from scratch. In the case of résumés in particular, it can be difficult for a content creators to create a large number of different sample résumés. For example, a content creator may tend to use a limited number of job skills, job titles, or work history repeatedly in the résumé samples, as it can be quite difficult to constantly originate new and diverse content. Generally, most individuals will gravitate to careers, work histories and education backgrounds with which they are most familiar. Consequently, even though a content creator may generate a large number of résumés, these résumés will most likely be fairly similar to each other or at best fall into one of several limited groupings. In other words, they will lack the content diversity necessary to be useful to a wide audience. For example, a content creator with a background in engineering may tend to create résumés that are more heavily focused on engineering/technical fields. On the other hand, a content creator experienced in customer service industries may instead develop résumés that gravitate to customer service jobs. Similarly, education level and background may influence the content of the sample résumés produced.

These unconscious biases can lead to content that does not appeal, or seem relevant, to entire groups of potential customers or subscribers. In other words, when done as a (human) mental process, the results are objectively and subjectively lacking. By leveraging generative AI to generate content, which may then be used as-is, or as a starting point, e.g., outline, for a new sample résumé, aspects of the present disclosure can assist in creating a diverse collection of sample résumés. In this way, more diverse and comprehensive content may be created that will appeal to more and larger groups of individuals. In other words, the impact of the generative AI is to improve the process in a way that a human inherently cannot due to, for example, inherent bias.

Additionally, sample résumés that are engaging and showcase the services available through a résumé creation platform can require significant labor on the part of the content creator. Thus a content creator may create only a few sample résumés per hour. However, by applying aspects of the present disclosure, high quality sample résumés can be created in significantly less time. In particular, content creators may no longer be burdened with originating content. Instead, the content creators can focus on editing the content produced by the AI model, and on the formatting and other visual aspects of the sample résumé.

In an effort to enhance clarity and maintain brevity, aspects of the present disclosure will be described herein below with respect to résumé content creation. However, aspects of the present disclosure are equally applicable to other types of content creation, such as articles, blog posts, graphics and images, and the like.

### Example User Interface

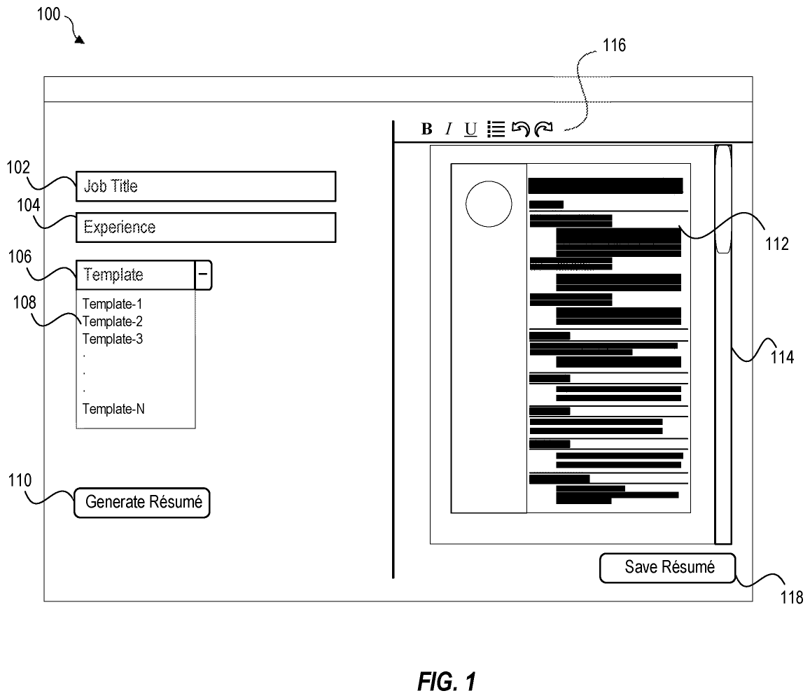

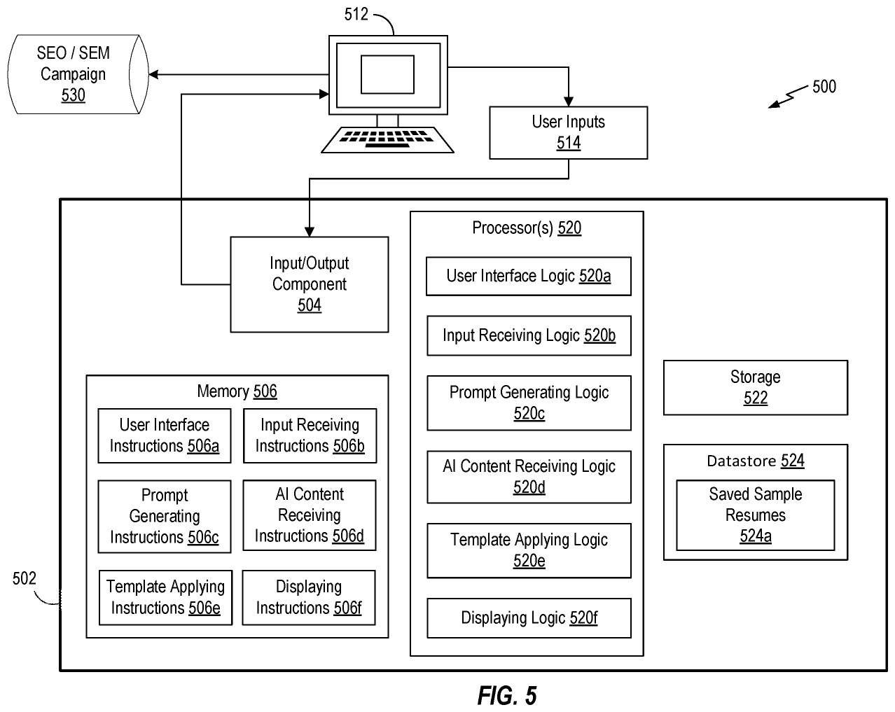

FIG. 1 depicts an example user interface (UI) 100, displayed on a workstation, such as workstation 512 shown in FIG. 5, and provided by a processing system implementing aspects of the present disclosure, such as processing system 502 shown in FIG. 5. The UI 100 shown in FIG. 1 is a graphical user interface (GUI), however in the context of the present disclosure, it is understood that the UI 100 is not limited to a GUI, but rather may be implemented in other forms, such as spoken prompts, for example, which may be advantageous for users that are visually impaired. For brevity, the present disclosure will focus on a graphical version of the UI 100. In the embodiments described herein, the UI 100 is treated as being provided by a separate processing system 502 to a workstation 512, however, aspects of the present disclosure are not limited to this arrangement alone. Rather, the UI 100 may, in some embodiments, by program code (e.g., software application) that is stored on, and executed by the workstation 512. The program code provides bi-directional communication between the UI 100 and the processing system 502.

The UI 100 may include a plurality of interactive elements, such as text input fields, drop-down menus, text edit fields, buttons, and the like. In particular, UI 100, in certain aspects of the present disclosure, presents a job title field 102 configured to receive a job title from a user (e.g., content creator). In addition, the UI 100 may provide access to previously saved job titles. The saved job titles may include, in certain aspects of the present disclosure, job titles that were previously entered by the user in the job title field 102 and subsequently saved in a “recent job titles” list. In certain aspects of the present disclosure, the saved job titles may include job titles entered by other users in a job title field on separate workstation.

In certain aspects of the present disclosure, the UI 100 may provide an interactive element, such as a text input field or drop-down menu, configured as an experience setting 104 allowing the user to indicate number of years of experience. In addition, other résumé parameters specifying the desired content of the sample résumé, such as education level, number of prior employers, and the like, may also be set through additional interactive elements, or collected into a settings UI.

The user is provided with a list of templates 108 from which to select a template to be applied to the sample résumé being generated. The list of templates 108 may be presented to the user in the form of a template drop-down menu 106. The templates are pre-designed and stored in a templates database. The templates database may be stored in a mass storage device installed on the processing system 502, such as storage 522. Alternatively the templates database may be stored in a cloud or other remote, network-accessible storage.

Actuating the “Generate Résumé” button 110 causes the job title shown in the job title field 102 to be transmitted to the processing system 502 and subsequently to the selected AI model. The response text received from the AI model by the processing system 502 is presented in an output field 114 as a sample résumé 112 with the template selected from the template drop-down menu 106 applied thereto. In certain aspects of the present disclosure, the user can change the template applied to the response text shown in output field 114 by selecting a different template from the list of templates 108 presented by the template drop-down menu 106.

In certain aspects of the present disclosure the output field 114 is configured to allow the user to edit the text of the sample resume. Moreover, the output field 114 may, in certain aspects of the present disclosure, include editing tools 116, such as tools for bolding, underlining, and italicizing, spell checking, and the like.

Once the sample résumé is acceptable to the user (e.g., content creator), the sample résumé can be saved by actuation of a save button 118. The sample résumé may be saved to a datastore on the processing system 502, such as datastore 524 shown in FIG. 5. Alternatively, the sample résumé may be stored to storage space allocated by a cloud storage service.

Certain aspects of the present disclosure, as described above, allows a content creator to generate a résumé by entering a job title in the job title field 102, select a template 108 from the template drop-down menu 106, and click the “Generate Résumé” button 110. Within a short period of time, a sample résumé 112 have content generated by the AI model is displayed in the output field 114. In contrast, a conventional method of generating a résumé would require significantly more time and effort on the part of the content creator. In particular, the content creator would be required to manually create each employment history, educational background, skills, and summary, for each sample résumé. Moreover, the content of each sample résumé created by the content creator would need to be different. The manual method of creating a sample résumé, thus, becomes a lengthy process for the content creator. Consequently, aspects of the present disclosure provide a clear improvement in the quantity, quality and diversity of content generated over the conventional methods.

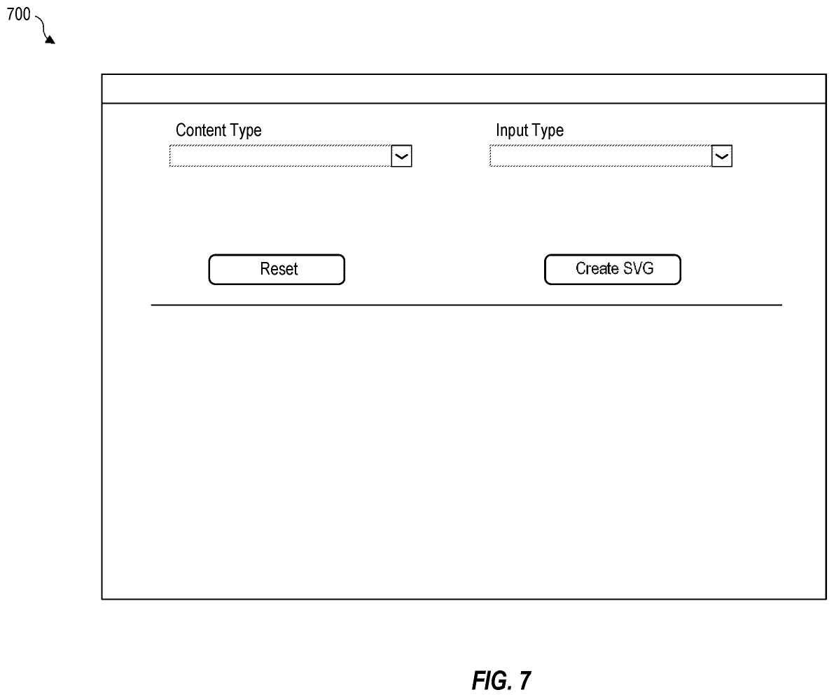

FIGS. 7-12 depicts another example user interface 700 that is configured to implement aspects of the present disclosure. Additionally, FIGS. 7-12 show the user interface 700 at several stages during use. Thus, FIGS. 7-12 will be discussed in conjunction with the process represented thereby. FIG. 7, the user interface 700 is shown in an initial state presented to a user upon loading a content generating application or webpage.

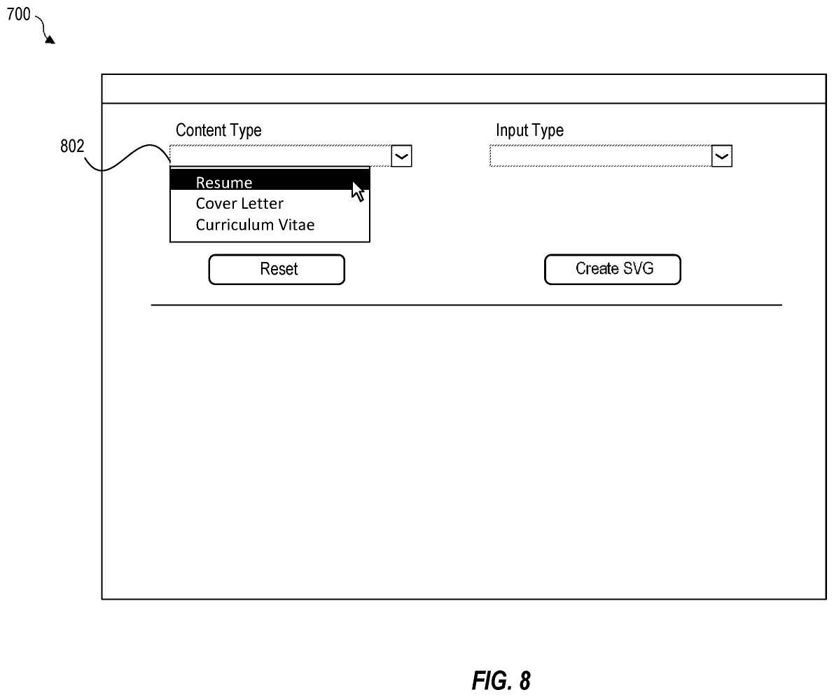

At FIG. 8, the user begins by selecting the content type that should be generated by way of an interactive element, such as a content type drop-down menu 802. Here, the user selects resume as the content type. However, the user may, alternatively, select to generate cover letters or curriculum vitae (CVs), as well.

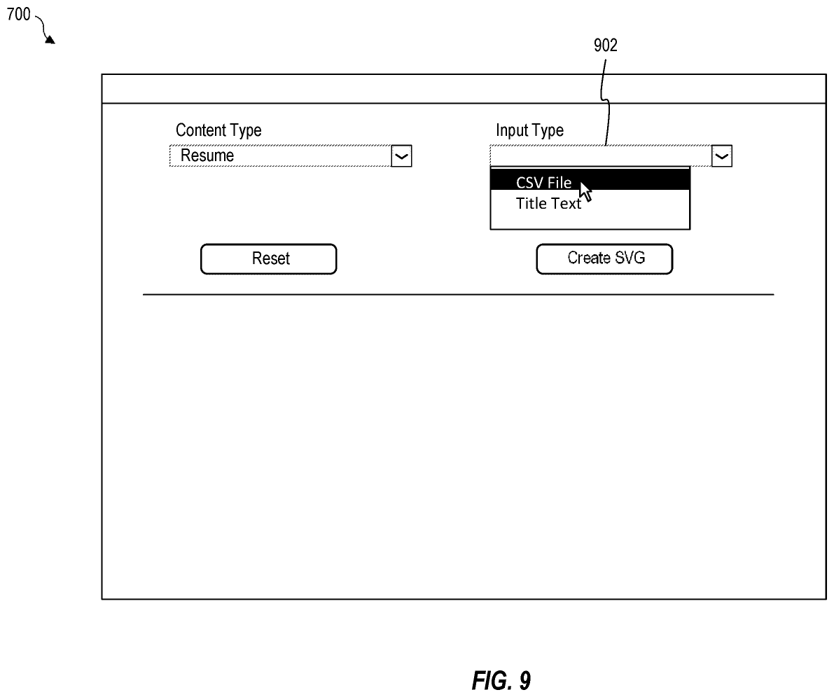

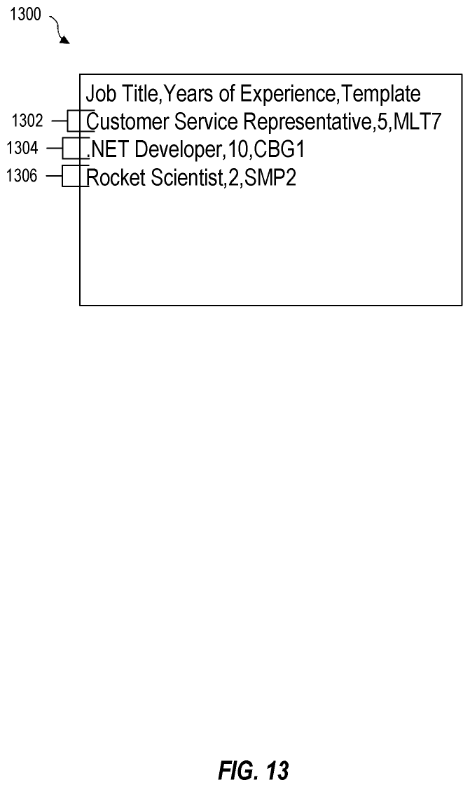

Next, at FIG. 9, the user selects the input type by way of an interactive element, such as a input type drop-down menu 902. Here the user selects CSV File as the input type. Alternatively, the user may select Title Text as the input type, which allows the user to manually enter job title and experience text in text fields as described above with respect to FIG. 1. Choosing CSV File as the input type allows the user to generate content in bulk by providing a file, such as CSV file 1300 shown in FIG. 13, containing job title, experience level, and résumé template for each résumé being generated.

FIG. 13 provides a sample CSV file 1300 with three entries 1302, 1304 and 1306. Each entry includes a job title, years of experience and a template separated by a comma. Thus, the first entry 1302 specifies a job title of “customer service representative” with 5 years of experience, and a résumé template “MLT7”. For brevity, the sample CSV file 1300 shows only three entries 1302, 1304, and 1306, however, in practice, a CSV file may contain any number of entries limited only by file size and processing constraints. While aspects of the present disclosure are described herein as using a file in which the values use a comma delimited (CSV) structure, other delimiting characters may be used instead of or in addition to CSV, for example, tab-delimited, semi-colon-delimited, and the like, without deviating from the scope and intent of the present disclosure.

The CSV file, such as CSV file 1300, is processed by backend processing system, such as the processing system 502 shown in FIG. 5, to generate, in the case of CSV file 1300, three résumés—a first resume for customer service representative, a second for a .NET developer, and a third for a rocket scientist.

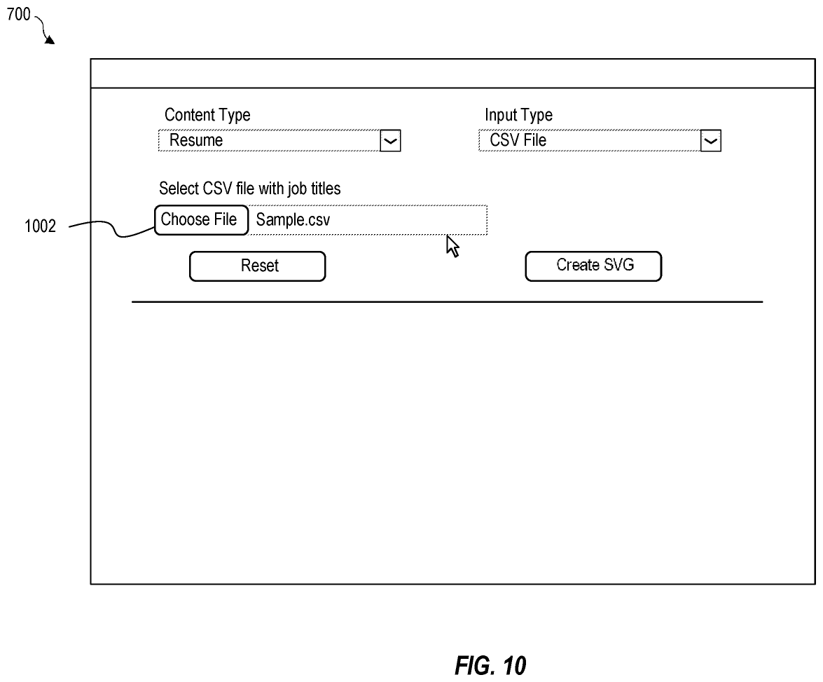

By selecting CSV File as the input type, the user interface 700 is updated with a file entry field 1002, shown in FIG. 10. The file entry field 1002 allows the user to choose a particular CSV file for the backend processing system to process in order to bulk generate résumés. Clicking on the file entry field 1002 may present the user with a file chooser interface, accessed through operating system application programming interfaces (APIs) of the workstation. The file chooser interface may expose at least a portion of the file system of the workstation to the user, and allows the user to navigate the file system structure to locate and select a desired CSV file.

However, if the user had selected Title Text as the input type, the file entry field 1002, would instead be replaced with interactive elements, such as the job title field 102, the experience setting 104, and the template drop-down menu 106 shown in FIG. 1.

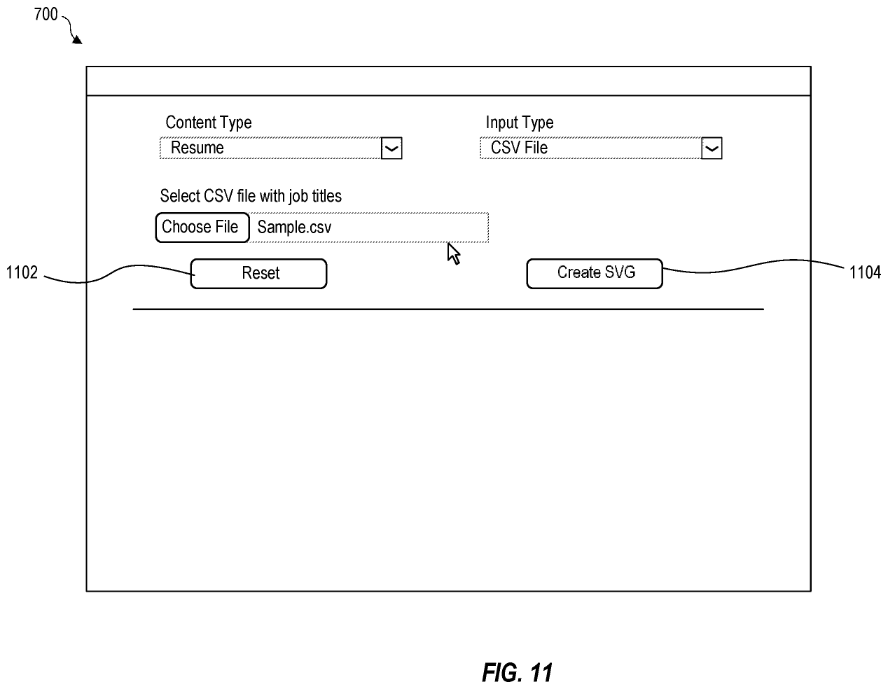

FIG. 11 shows the user interface 700 as presented to a user once the content type has been selected, the input type has been set to CSV file, and a CSV file has been chosen. At this stage, the user can select to have the CSV file processed and the requested résumés generated by click the create SVG button 1104. A reset button 1102 is also provide on the user interface 700 that may be selected at any stage to reset the user interface 700 back to the state shown in FIG. 7.

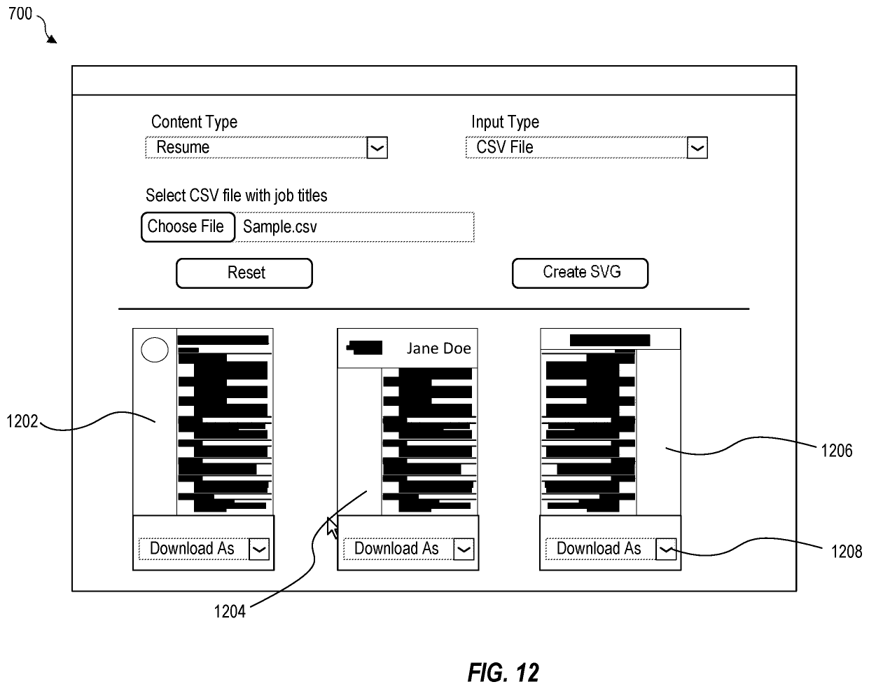

FIG. 12 shows the user interface 700 at a final stage of the process. The backend processing system provides thumbnails of the generated sample résumés 1202, 1204, and 1206 conforming to corresponding entries in the selected CSV file, such as CSV file 1300 in FIG. 13. In certain implementations of aspects of the present disclosure, clicking on the thumbnail of a sample résumé 1202, 1204, and 1206 may allow the user to edit the sample résumé 1202, 1204, and 1206 in a separate document editing interface (not shown). Document editing may be implemented as a component service of the backend processing system. Alternatively, document editing may be provided by API calls to one or more cloud-based applications or services.

Once the user is satisfied with each sample résumé 1202, 1204, and 1206, each sample résumé 1202, 1204, and 1206 may be downloaded as one of several file formats, such as SVG, PNG, PDF or DOCX formats, for example, by selecting an appropriate format in the “Download as” drop-down menu 1208. In certain implementations, a save dialog may be displayed, allowing the user to provide a name and location for the sample résumé 1202, 1204, and 1206. Additionally, certain implementations may include a bulk save/download button allowing the user to save all the generated résumés at once. The bulk save button may execute a process that assigns each sample résumé 1202, 1204, and 1206 a default name with one or more digits appended thereto, for example sample_resume-001.svg, or the like.

### Example Process

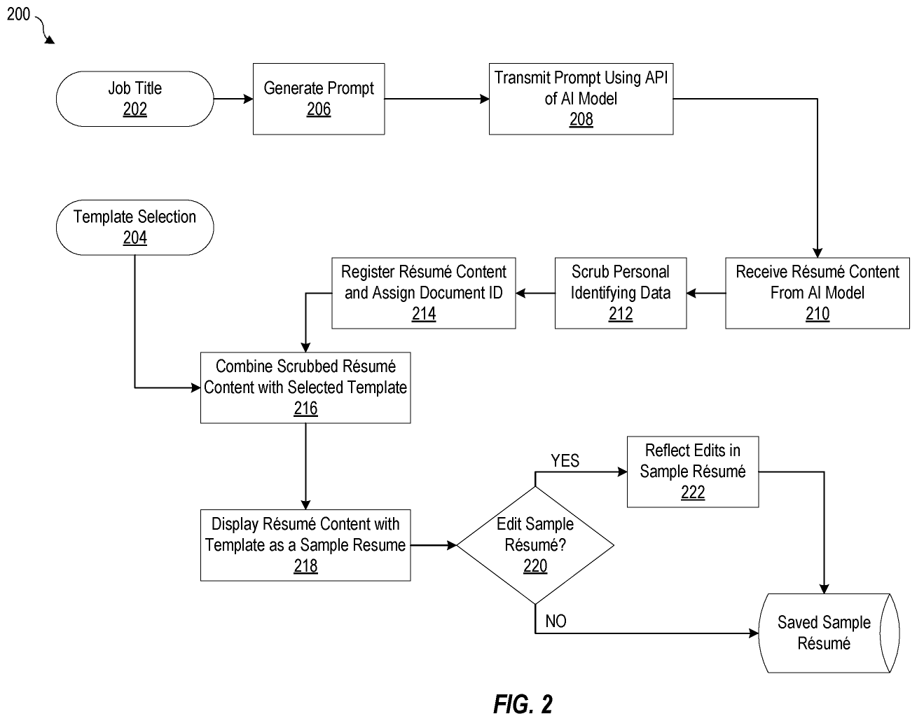

FIG. 2 depicts an example block representation of a process 200 performed by a backend processing system, such as the processing system 502 shown in FIG. 5. The process begins at block where a job title is received from a UI (e.g., UI 100 of FIG. 1). In certain aspects of the present disclosure, the process 200 may receive number of years of experience set by the user through an interactive element (e.g., experience setting 104 of FIG. 1).

At block 204, the process 200 receives a template selection made by the user via an interactive element of the UI 100 (e.g., template drop-down menu 106 of FIG. 1). As noted above the available templates may be stored in a template database on a storage device, (e.g., storage 522 of FIG. 5). The process retrieves the selected template from the template database for use later in the process 200.

At block 206 a prompt is generated by the process 200. The prompt is customized with the receive job title, number of years of experience, preset AI parameters, and any additional résumé parameters set by the user. The preset AI parameters may include AI model, temperature, context window, frequency, presence penalty, top-k, and top-p. Adjustment of the settings and the particular AI model selected can affect the resulting output from the AI model, and thus, the sample résumé generated. Additionally, certain settings may alter the degree of variation in the results generated by the AI model. For example, a high temperature value can technically generate highly dynamic content, but such a temperature setting can also result in output that may need to be extensively edited to conform to the desired output. In contrast, a low temperature setting may provide highly deterministic content, and thus each output generated from a given prompt will be very similar. Thus, optimal values for the various AI model parameters may need to be determined by experimentation and the constraints of a particular implementation. Through experimentation, suitable temperature values can be determined for different languages. In some implementations, the other parameters may be set to default values. Although, experimentation may identify non-default values that may be optimal of particular implementations.

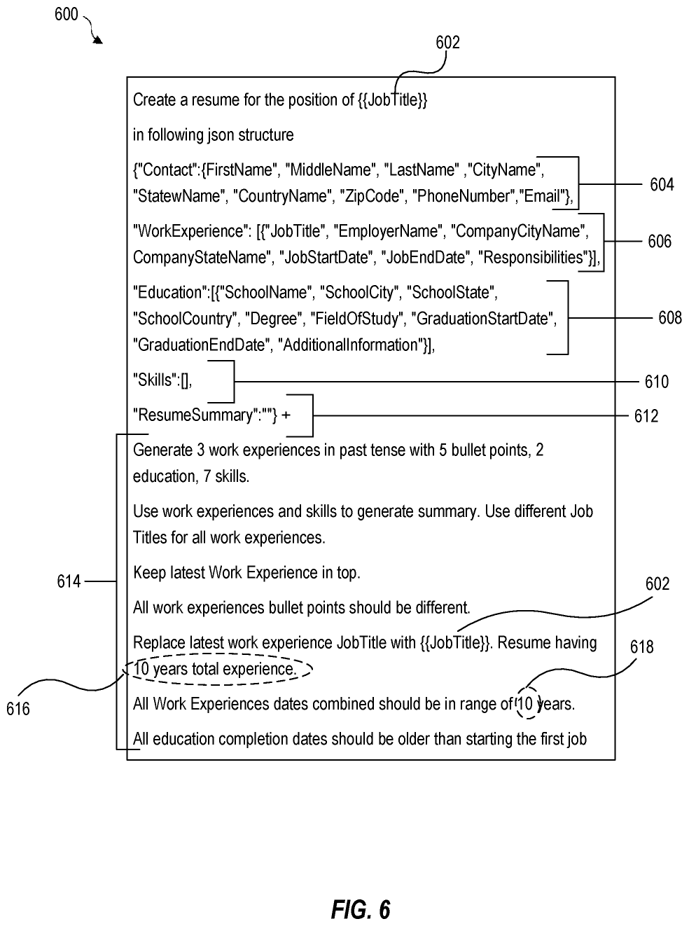

The customized prompt is transmitted, by the process 200, to the selected AI model at block 208. An example customizable prompt template 600 is shown in FIG. 6.

FIG. 6 shows a prompt template 600 that includes one user-provided input 602 (e.g., variable), namely JobTitle. Thus, the prompt template is customized by a prompt generating routine (e.g., prompt generating logic 520c of FIG. 5) that replaces {{JobTitle}} with the actual job title text submitted by the user via a text field of the UI 100 (e.g., job title field 102 of FIG. 1). Additionally, the prompt template 600 may include JSON formatting instructions, such contact format 604, work format 606, education format 608, skills format 610, and résumé format 612. Also, the prompt template may include response instruction 614 that describe the content of the response.

In certain aspects of the present disclosure, additional user-provided inputs can be applied as well. For example, rather than having a hardcoded “10 years total experience”, certain aspects of the present disclosure may include in the UI 100 a input field for accepting a numerical value representing a total number of years of experience and the prompt template above may be modified to replace “10 years total experience” 616 with “{{YearsOfExperience}} years total experience” and “in range of 10 years” 618 may be modified as “in range of {{YearsOfExperience}} years”. The similar modifications to the prompt template may be made for the number of work experiences generated, number of bullet points, number of skills, and the like, along with the addition of related interactive elements in the UI 100.

Multiple prompt templates can be implemented as well. For example, a first prompt template, such as prompt template 600, may be used when only a job title is provided. A second prompt template may be used in the user provides number of years of experience. The appropriate prompt template may be selected automatically by the backend processing system based on the values entered by the user.

The JSON formatting instructions shown in the prompt template 600 is provided as an example. Other formats can be defined as appropriate for the particular implementation of the present disclosure.

At 210, the process 200 receives the output from the AI model as résumé content. The output may be formatted as JSON, XML, or any other appropriate structured content. In certain aspects of the present disclosure, the output format may be selected by the user via the settings button 104 of the UI 100. In implementations in which the output format is selectable, the prompt template 600 may include variables for defining the selected output format.

The AI model is being instructed to provide résumé content including contact information 604 as shown in FIG. 6, and thus, the AI model may include personal information such as names and addresses of real people in the result. While the AI model will most likely not provide real names and addresses, aspects of the present disclosure implement a procedure to ensure that real personal data is not inadvertently included in the sample résumé. To that end, at block 212, the process 200 checks the résumé content for the presence of any personal data that may have been generated by the AI model. Any personal data, such as applicant name, email address, home address, and the like, that is detected in the résumé content by the process 200 is removed and replaced with predefined “dummy” data at the backend processing system. For example, an applicant's name may be replaced by a generic “John Doe”, “Jane Doe” or nonsense name. In certain aspects of the present disclosure, a list of approved replacement pseudo-personal data for each category may be used to replace the personal data supplied by the AI model. In certain aspects of the present disclosure, process 200 replaces any personal data with the predefined data, thus, avoiding the potential risk of including real personal data in the sample résumé.

At block 214, the process 200 registers the résumé content and assigns a document ID to the résumé content. Registering the résumé content entails populating predefined fields in a resume database entry. The document ID allows the résumé content associated with the document ID to be easily retrieved from the résumé database. By registering the résumé content, the résumé content is made available to all users of the system via a dashboard UI.

At block 216, the process 200 combines the résumé content with the template selected by the user and retrieved at block 204 from the template database. The template, also known as a “skin”, may be written using cascading stylesheets (CSS), syntactically awesome stylesheets (SASS), or other appropriate scripting languages. In certain aspects of the present disclosure, block 216 may be performed at the processing system 502. In certain other embodiments, block 216 may be performed by the user's workstation, (e.g., workstation 512 of FIG. 5). The finalized sample résumé (e.g., résumé content with a skin applied thereto) may be saved or downloaded or shared in any appropriate file format, such as portable document format (PDF), scalable vector graphics (SVG) format, or Joint Photographic Experts Group (JPEG) format.

At block 218, the process 200 displays the sample résumé (i.e., the résumé content and selected template) in an output field of the UI 100, such as output field 114 of FIG. 1. As described above with respect to FIG. 1, the sample résumé displayed in the output field 114 may be edited by the user.

Once the user has reviewed the sample résumé displayed in the output field 114 and made any desired edits, the user may approve the sample résumé by actuating a save button on the UI 100, such as save button 118 of FIG. 1, the process 200 proceeds to block 220. At block 220 the process 200 determines if edits were made to the original résumé content displayed in the output field 114. If no edits were made to the original résumé content by the user, the sample résumé is saved to a datastore (e.g., datastore 524 of FIG. 5) as a saved sample résumé (e.g., 524a of FIG. 5). However, if edits were made by the user, the edits are reflected in the résumé content stored in the résumé database by the process 200 at block 222, and then the sample résumé, as edited, is stored in a datastore 524 as a saved sample résumé 524a.

### Example Methods

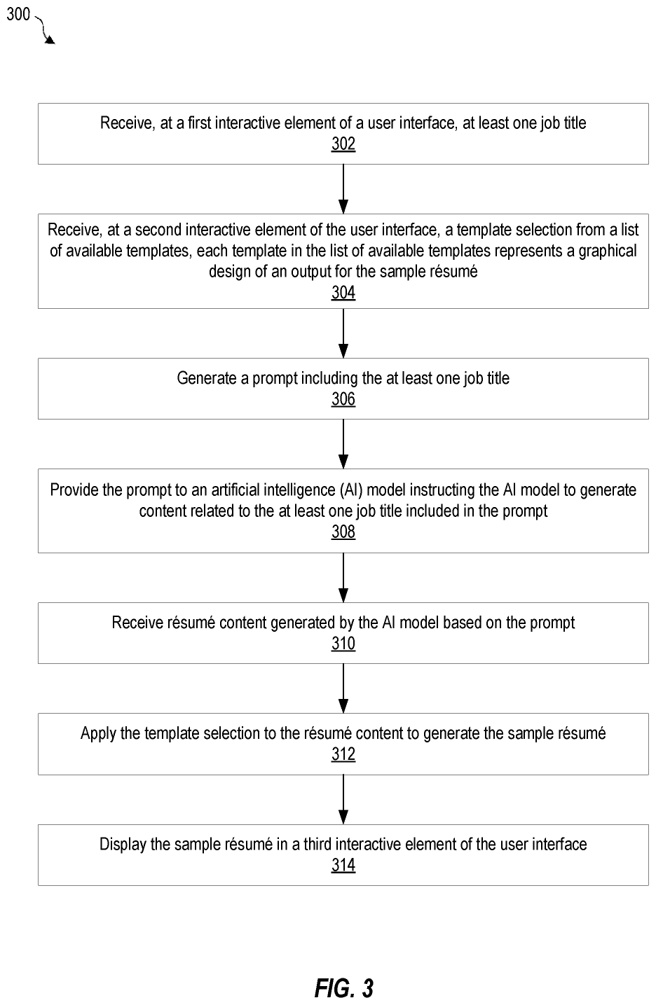

FIG. 3 depicts a method 300 for dynamically creating a sample résumé at a user workstation. The method 300 may be executed on a workstation (e.g., workstation 512 of FIG. 5) and in communication with a processing system (e.g., processing system 502 of FIG. 5).

At block 302, the method 300 begins by receiving, at a first interactive element (e.g., job title field 102 of FIG. 1) of a user interface (e.g., UI 100 of FIG. 1), at least one job title.

At block 304, the method 300 receives, at a second interactive element (e.g., template drop-down menu 106 of FIG. 1) of the user interface. The template is selected from a list of available templates (e.g., template list 108 of FIG. 1). Each template in the list of available templates represents a graphical design of an output for the sample résumé. In certain aspects of the present disclosure, the template, also known as a “skin”, may be written using cascading stylesheets (CSS), syntactically awesome stylesheets (SASS), or other appropriate scripting languages.

At block 306, the method 300 generates a prompt including the at least one job title. As described above, with reference to FIG. 2, the prompt is generated by customizing a prompt template, such as the prompt template 600 shown in FIG. 6.

At block 308, the method 300 provides the prompt to an artificial intelligence (AI) model instructing the AI model to generate content related to the at least one job title included in the prompt. In certain aspects of the present disclosure, additional code can be added to the prompt for customizing the AI model by using application programming interfaces (APIs) of the target AI model.

By way of the prompt, the content creator (e.g., user) may provide all the necessary information to the AI model to generate a sample résumé. In contrast, the conventional process for creating a sample résumé would involve the content creator manually drafting the work history, skills, education background, and resume summary from scratch, which can be a lengthy process. Moreover, the need for each sample résumé to have different content, makes the manual task of creating the content even more difficult and laborious for the content creator. Thus, the prompt, crafted in accordance with aspects of the present disclosure, may provide results that are sufficiently different from one another in significantly less time.

At block 310, the method 300 receives résumé content generated by the AI model based on the prompt. In certain aspects of the present disclosure, the résumé content received from the AI model is sanitized to remove text that may contain personal information. The removed text is replaced with generic data, such as “Jane Doe” as the applicant name, for example. The generic data may be selected by the processing system from a previously created list of approved data. Multiple lists may be maintained-one for names, one for addresses, and one for contact information (telephone and email), for example. As these lists will have dummy information, there is little danger of inadvertently including real personal information in the sample résumés.

At block 312, the method 300 applies the template selection to the résumé content to generate a sample résumé (e.g., sample résumé 112 of FIG. 1).

At block 314, the method 300 displays the sample résumé in a third interactive element (e.g., output field 114 of FIG. 1) of the user interface. In certain aspects of the present disclosure, the text of the sample résumé may be edited while being displayed in the output field. When the user is satisfied with the sample résumé, the sample résumé may be saved to a résumé database (e.g., datastore 524 of FIG. 5) as a saved sample résumé 524a shown in FIG. 5, for example. As shown in FIG. 3 and described above, a user is able to focus on editing the already prepared résumé content, and adding additional details at block 314, rather than expending the significant effort required to manually draft the résumé content initially.

Note that FIG. 3 is just one example of a method consistent with aspects described herein, and other methods having fewer, additional, and/or alternative blocks are possible consistent with this disclosure.

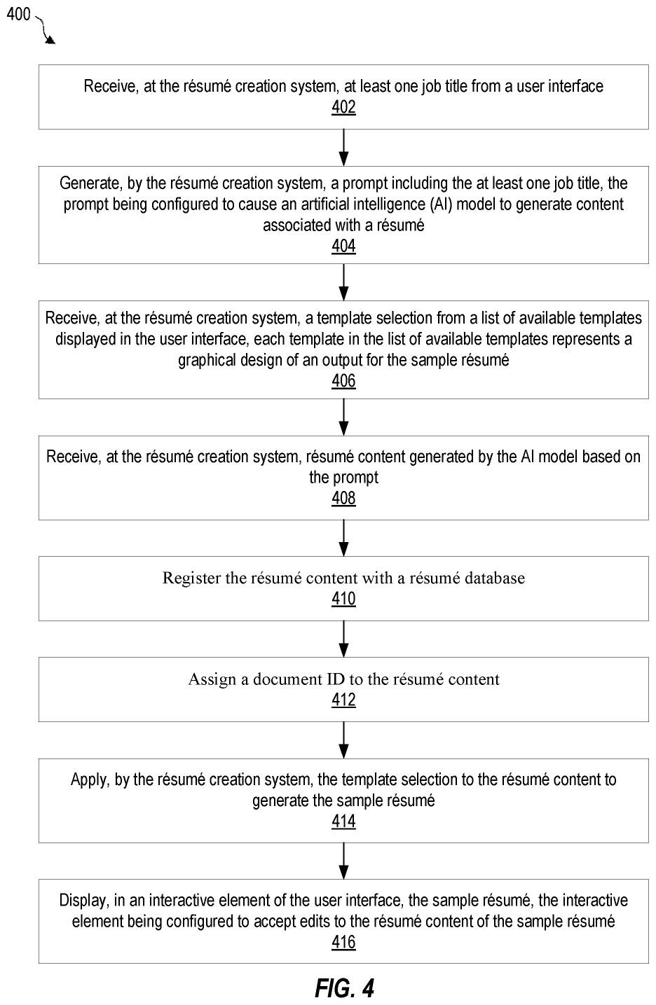

FIG. 4 depicts a method 400 for dynamically creating a sample résumé at a résumé creation system. The method 400 may be executed on a processing system (e.g., processing system 502 of FIG. 5), operating as the résumé creation system, and in communication with a workstation (e.g., workstation 512 of FIG. 5).

At block 402, the method 400 begins by receiving, at the résumé creation system, at least one job title from a user interface (e.g., UI 100 of FIG. 1) implemented on the workstation. Specifically, the received job title is entered by a user into, for example, a job title field 102 of the UI 100, as described above and shown in FIG. 1.

At block 404, the method 400 generates, by the résumé creation system, a prompt including the at least one job title. The prompt is configured to cause an artificial intelligence (AI) model to generate content associated with a résumé. As described above, with reference to FIG. 2, the prompt is generated by customizing a prompt template, such as the prompt template 600 shown in FIG. 6.

By way of the prompt, the content creator (e.g., user) may provide all the necessary information to the AI model to generate a sample résumé. In contrast, the conventional process for creating a sample résumé would involve the content creator manually drafting the work history, skills, education background, and resume summary from scratch, which can be a lengthy process. Moreover, the need for each sample résumé to have different content, makes the manual task of creating the content even more difficult and laborious for the content creator. Thus, the prompt, crafted in accordance with aspects of the present disclosure, may provide results that are sufficiently different from one another in significantly less time.

At block 406, the method 400 receives, at the résumé creation system, a template selection (via e.g., a template drop-down menu 106 of FIG. 1) from a list of available templates (e.g., template list 108 of FIG. 1) displayed in the user interface. Each template in the list of available templates represents a graphical design of an output for the sample résumé. In certain implementations of aspects of the present disclosure, a bulk processing feature may be provided in which the at least one job title and the template selection are provided in a text file containing a plurality of job titles, each associated with a years of experience value and a résumé template name, such as the sample CSV file 1300 shown in FIG. 13.

At block 408, the method 400 receives, at the résumé creation system, résumé content generated by the AI model based on the prompt. In certain aspects of the present disclosure, the résumé content received from the AI model is sanitized to remove text that may contain personal information. The generic data may be selected by the résumé creation system from a previously created list of approved data. Multiple lists may be maintained, one for each category of personal information. Since these lists contain fake information, there is little danger of inadvertently including real personal information in the sample résumés.

At block 410, the method 400 registers the résumé content with a résumé database. In certain aspects of the present disclosure, registering the résumé content may entail creating a database entry having multiple fields. Each of the fields may be a résumé keyword, such as name, employer, education, position, and the like, and the values for the fields may be extracted from the résumé content provided by the AI model. In certain aspects of the present disclosure, the database may store the résumé content as comma separated values (CVS).

At block 412, the method 400 assigns a document ID to the résumé content to reference the location of the résumé content in the database. The document ID facilitates recall of an associated résumé content from the résumé content database.

At block 414, the method 400 applies, by the résumé creation system, the template selection to the résumé content to generate the sample résumé (e.g., sample résumé 112 of FIG. 1).

At block 416, the method 400 displays, in an interactive element (e.g., output field 114 of FIG. 1) of the user interface, the sample résumé. In certain aspects of the present disclosure, the interactive element is configured to accept edits to the résumé content of the sample résumé. When the user is satisfied with the sample résumé, the method 400 receives the approved sample résumé along with a save command. The approved sample résumé may be saved to a résumé database (e.g., datastore 524 of FIG. 5) as a saved sample résumé 524a shown in FIG. 5, for example.

Note that FIG. 4 is just one example of a method consistent with aspects described herein, and other methods having fewer, additional, and/or alternative blocks are possible consistent with this disclosure.

### Example Processing System

FIG. 5 depicts an example computing environment 500 in which aspects of the present disclosure may be implemented. As shown, the computing environment 500 may include a processing system 502 and a user workstation 512. The processing system 502 may be implemented as a desktop computer, server, mainframe, distributed computer architecture, cloud services, or the like. In certain aspects of the present disclosure, the processing system 502 may operate as a résumé creation system. In other embodiments, the processing system 502 may operate as one component of a résumé creation system.

The user workstation 512, in certain aspects of the present disclosure, may be co-located with, and in communication with the processing system 502 via a local area network (LAN). In other embodiments, the user workstation 512 may be remotely located with respect to the processing system 502, and communication between the user workstation 512 and the processing system 502 may be implemented via the Internet, a wide area network, or the like. The user workstation 512 may be any of a desktop computer system, notebook computer, tablet device, mobile phone device, or the like. While one workstation 512 is shown in FIG. 5, in practice any number of workstations may be present.

The processing system 502 may include an input/output (I/O) component 504, such as a network interface and associated computer-readable instructions (e.g., firmware) for facilitating communication between the processing system 502 and external devices, such as the user workstation 512, external storage, printers, etc. The I/O component 504 is configured to receive user inputs 514 from the user workstation 512, and transmit résumé related data (e.g., résumé content) to the user workstation 512.

The processing system 502 may also include one or more storage devices (e.g., storage 522 and datastore 524) and one or more processors, collectively referenced as processor 508.

Additionally, the processing system 502 may include memory 506 implemented by volatile and non-volatile memory, such as random access memory (RAM), flash memory, and read-only memory (ROM) respectively. In certain aspects of the present disclosure, the memory may be utilized as a RAM disk such that the memory is treated by the processing system as a mass storage device. Alternatively, some or all of a mass storage device, such as storage 522, may be configured and addressed by the processing system 502 as virtual memory. Thus, in such a context the memory 506 may be implemented as virtual memory allocated from addressable blocks of storage 522 rather than as physical RAM, ROM, or the like. Consequently, physical memory and storage, in the context of the present disclosure provide similar, and, in many cases, interchangeable functionality.

Processor(s) 508 are generally configured to retrieve and execute instructions stored in memory 506 and/or one or more storage 522, including local hard disk drives, solid-state storage devices optical storage devices, and the like. Similarly, processor(s) 508 are configured to retrieve and store application data residing in the storage 506. In certain aspects of the present disclosure, processor(s) 508 are included to be representative of a one or more central processing units (CPUs), graphics processing unit (GPUs), tensor processing unit (TPUs), accelerators, field programmable gate arrays (FPGAs), and other processing devices. The processor 520 is shown as including a number of logic blocks, such as user interface logic 520a, input receiving logic 520b, prompt generating logic 520c, AI content receiving logic 520d, template applying logic 520e, and displaying logic 520f. The logic blocks 520a-520f implement the actions expressed by respective computer-readable instructions 506a-506f.

In FIG. 5, computer-readable instructions 506a-506f are shown as being held in memory 506, generally. However, in practical operation, the computer-readable instructions, and related data may be held in memory, mass storage devices, or a combination of both. For example, the computer-readable instructions may be stored in one or more mass storage devices of storage 522 and during execution of the computer-readable instructions, all or part of the instruction code may be loaded into registers of the volatile memory 506. Thus, actual execution of some or all of the computer-readable instructions may occur from memory 506. In other embodiments, the computer-readable instructions are executed directly from the mass storage device, with runtime data being held in memory 506.

The storage 522 implements computer-readable storage for storing computer-readable instructions configured for implementing, by the processor 508, methods embodying aspects of the present disclosure, such as method 300 shown in FIG. 3, and method 400 shown in FIG. 4, as well as process 200 shown in FIG. 2. The computer-readable instructions may be loaded into memory 506 during runtime. In particular, the memory 506 includes user interface instructions 506a, input receiving instructions 506b, prompt generating instructions 506c, AI content receiving instructions 506d, template applying instructions 506c, and displaying instructions 506f. Additionally, the storage 522 may store data, such as résumé templates, and lists of replacements for personal information, for example.

The processing system 502 may host web services, via the user interface instructions 506b interacting with the user interface logic 520a, to provide a user interface (e.g., UI 100 of FIG. 1) having a job title field (e.g., job title field 102 of FIG. 1), a output field (e.g., output field 114 of FIG. 1), and one or more interactive elements (e.g., template drop-down box 106, generate résumé button 110, save résumé button 118, and settings button 104 of FIG. 1). The web-based UI may be implemented as one or more webpages stored in storage 522. The UI may be displayed to the user on a workstation 512 via a web browser, for example. In certain aspects of the present disclosure, the UI may be implemented as computer-executable code (e.g., application software) residing locally on the workstation 512 and executed by the processor of the workstation 512. The computer-executable code may access the processing system 502 via the Internet, for example, to receive data for populating the various fields and elements of the UI. For example, the computer-executable code may request a list of résumé templates from the processing system 502 to populate the template drop-down menu 106.

The input receiving instructions 506b interact with input receiving logic 520b of the processor 520 and the I/O component 504 to perform block 402 shown in FIG. 4, for example, such that the processing system 502 receives user inputs 514, such as a job title, from the workstation 512. The user inputs 514 may include a job title entered by a user in the job title field 102 of FIG. 1. The user inputs 514, in certain aspects of the present disclosure, may be expanded to include various parameters, such as AI model, and AI specific parameters, such as temperature, context window, frequency, presence penalty, top-k, and top-p, may be implemented using appropriate interactive UI elements. In addition, résumé parameters specifying the desired content of the sample résumé, such as number of years of experience, education level, number of prior employers, and the like, may also be provided as user inputs 514.

Additionally, the input receiving instructions 506b interact with input receiving logic 520b to perform block 402 shown in FIG. 4. Specifically, the input receiving instructions 506b causes the processor 520, via input receiving logic 520b to select a résumé template from the list of available résumé template in response to a résumé template selection made with the résumé template drop-down menu 106 shown in FIG. 1, for example.

The prompt generating instructions 506c interact with prompt generating logic 520c of the processor 520 to perform block 404 of FIG. 4, for example. The prompt generating instructions 506c causes the processor 508, via prompt generating logic 520c, to customize a prompt template, such as the prompt template 600 shown in FIG. 6, with the job title and other parameters received as user inputs 514.

By way of the prompt generating logic, the content creator (e.g., user) may provide all the necessary information to the AI model to generate a sample résumé. In contrast, the conventional process for creating a sample résumé would involve the content creator manually drafting the work history, skills, education background, and resume summary from scratch, which can be a lengthy process. Moreover, the need for each sample résumé to have different content, makes the manual task of creating the content even more difficult and laborious for the content creator. Thus, the prompt, generated by the prompt generating logic in accordance with aspects of the present disclosure, may provide results that are sufficiently different from one another in significantly less time.

The AI content receiving instructions 506d interact with AI content receiving logic 520d of the processor 520 to perform block 408 of FIG. 4, for example. The AI content receiving instructions 506d causes the processor 508, via AI content receiving logic 520d, to receive text-based résumé content from the selected AI model based on the customized prompt.

Additionally, the AI content receiving instructions 506d causes the processor 520, via AI content receiving logic 520d, to perform blocks 410 and 412 of FIG. 4, for example. Namely, the AI content receiving instructions 506d causes the processor 520 to register the résumé content by creating a database entry for the résumé content, and assign a document ID thereto to facilitate retrieval of the associated résumé content from the database. In certain aspects of the present disclosure, the AI content receiving instructions 506d causes the processor 520 to scrub personal information from the résumé content before registering the résumé content, as described above with respect to block 212 of FIG. 2. Scrubbing the résumé content includes removing potential personal information from the résumé content received from the AI model and replacing the information with data from a list of fake personal information.

The template applying instructions 506e interact with template applying logic 520e of the processor 520 to perform block 414 of FIG. 3, for example. The template applying instructions 506d cause the processor 520, via template applying logic 508d, to apply the résumé template selected by the user via the résumé template drop-down menu 106 to the scrubbed résumé content to generate a sample résumé.

The displaying instructions 506f interact with displaying logic 520f of the processor 520 to perform block 416 of FIG. 4, for example. The displaying instructions 506f cause the processor 520, via displaying logic 520f, to display the sample résumé (e.g., sample résumé 112 of FIG. 1) in an output field (e.g., output field 114 of FIG. 1) of the UI. Displaying the sample résumé may further involve the user interface instructions 506a, user interface logic 520a and I/O component 504 to display the sample résumé on the workstation 512. In certain aspects of the present disclosure, the displaying instructions 506f and displaying logic 520f provide editing functionality, allowing the user at the workstation 512 to edit the sample résumé. The edits may include modifying the text of the sample résumé. The edits may also include changing the résumé template being applied to the résumé content. Additionally, by way of user inputs 514 (e.g., save résumé button 118 of FIG. 1) the approved sample résumé, including any edits, may be saved by the processing system 502 in the datastore 524 as a saved sample résumé 524a.

The saved sample résumés 524a may be used for marketing and tutorial purposes. For example, the saved sample résumé 524a may be uploaded to search engine optimization (SEO) service or search engine marketing (SEM) service and included in a SEO/SEM campaign. Where a variety of different sample résumé for different job titles and using different résumé templates can be used to showcase a résumé creation service.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of dynamically creating a sample résumé at a user workstation, comprising: receiving, at a first interactive element of a user interface, at least one job title; receiving, at a second interactive element of the user interface, a template selection from a list of available templates, each template in the list of available templates represents a graphical design of an output for the sample résumé; generating a prompt including the at least one job title; providing the prompt to an artificial intelligence (AI) model instructing the AI model to generate content related to the at least one job title included in the prompt; receiving résumé content generated by the AI model based on the prompt; applying the template selection to the résumé content to generate the sample résumé; and displaying the sample résumé in a third interactive element of the user interface.

Clause 2: The method of Clause 1, further comprising receiving, by way of the third interactive element, edits to the résumé content of the sample résumé.

Clause 3: The method of Clause 1 or 2, wherein generating the prompt further comprises including instructions directing the AI model to structure the content in a résumé format including an applicant name, an applicant address, educational history, and work history.

Clause 4: The method of any one of Clauses 1-3, further comprising scrubbing the résumé content to remove personal data present in the résumé content generated by the AI model prior to displaying the sample résumé.

Clause 5: The method of any one of Clauses 1-4, further comprising replacing personal information in the résumé content with generic personal information.

Clause 6: The method of any one of Clauses 1-5, further comprising using the sample résumé for at least one of search engine optimization (SEO) and search engine marketing (SEM) campaigns to drive web traffic to a résumé builder website.

Clause 7: A method of dynamically creating a sample résumé at a résumé creation system, comprising: receiving, at the résumé creation system, at least one job title from a user interface; generating, by the résumé creation system, a prompt including the at least one job title, the prompt being configured to cause an artificial intelligence (AI) model to generate content associated with a résumé; receiving, at the résumé creation system, a template selection from a list of available templates displayed in the user interface, each template in the list of available templates represents a graphical design of an output for the sample résumé; receiving, at the résumé creation system, résumé content generated by the AI model based on the prompt; applying, by the résumé creation system, the template selection to the résumé content to generate the sample résumé; and displaying, in an interactive element of the user interface, the sample résumé, the interactive element being configured to accept edits to the résumé content of the sample résumé.

Clause 8: The method of Clause 7, further comprising receiving, by way of the interactive element, edits to the résumé content of the sample résumé.

Clause 9: The method of Clause 7 or 8, wherein generating the prompt further comprises including instructions directing the AI model to structure the content in a résumé format including an applicant name, an applicant address, educational history, and work history.

Clause 10: The method of any one of Clauses 7-9, further comprising scrubbing the résumé content to remove personal data present in the résumé content generated by the AI model prior to displaying the sample résumé.

Clause 11: The method of any one of Clauses 7-10, further comprising replacing personal information in the résumé content with generic personal information.

Clause 12: The method of any one of Clauses 7-11, further comprising: registering the résumé content with a résumé database; and assigning a document ID to the résumé content.

Clause 13: The method of any one of Clauses 7-12, wherein the at least one job title and the template selection are provided in a text file containing a plurality of job titles, each associated with a years of experience value and a résumé template name, the text file being structured as a comma-separated-value (CSV) file.

Clause 14: A processing system, comprising: a memory comprising computer-executable instructions; and a processor configured to execute the computer-executable instructions and cause the processing system to perform a method in accordance with any one of Clauses 1-12.

Clause 15: A processing system, comprising means for performing a method in accordance with any one of Clauses 1-12.

Clause 16: A non-transitory computer-readable medium storing program code for causing a processing system to perform the steps of any one of Clauses 1-12.

Clause 17: A computer program product embodied on a computer-readable storage medium comprising code for performing a method in accordance with any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of dynamically creating a sample résumé at a user workstation, comprising:
receiving, at a first interactive element of a user interface, at least one job title;
receiving, at a second interactive element of the user interface, a template selection from a list of available templates, each template in the list of available templates represents a graphical design of an output for the sample résumé;
generating a prompt including the at least one job title;
providing the prompt to an artificial intelligence (AI) model instructing the AI model to generate content related to the at least one job title included in the prompt;
receiving résumé content generated by the AI model based on the prompt;
applying the template selection to the résumé content to generate the sample résumé; and
displaying the sample résumé in a third interactive element of the user interface.

2. The method of claim 1, further comprising receiving, by way of the third interactive element, edits to the résumé content of the sample résumé.

3. The method of claim 1, wherein generating the prompt further comprises including instructions directing the AI model to structure the content in a résumé format including an applicant name, an applicant address, educational history, and work history.

4. The method of claim 3, further comprising scrubbing the résumé content to remove personal data present in the résumé content generated by the AI model prior to displaying the sample résumé.

5. The method of claim 4, further comprising replacing the personal data in the résumé content with generic personal information.

6. The method of claim 1, further comprising using the sample résumé for at least one of search engine optimization (SEO) and search engine marketing (SEM) campaigns to drive web traffic to a résumé builder website.

7. A method of dynamically creating a sample résumé at a résumé creation system, comprising:
receiving, at the résumé creation system, at least one job title from a user interface;
generating, by the résumé creation system, a prompt including the at least one job title, the prompt being configured to cause an artificial intelligence (AI) model to generate content associated with a résumé;
receiving, at the résumé creation system, a template selection from a list of available templates displayed in the user interface, each template in the list of available templates represents a graphical design of an output for the sample résumé;
receiving, at the résumé creation system, résumé content generated by the AI model based on the prompt;
applying, by the résumé creation system, the template selection to the résumé content to generate the sample résumé; and
displaying, in an interactive element of the user interface, the sample résumé, the interactive element being configured to accept edits to the résumé content of the sample résumé.

8. The method of claim 7, further comprising receiving, by way of the interactive element, edits to the résumé content of the sample résumé.

9. The method of claim 7, wherein generating the prompt further comprises including instructions directing the AI model to structure the content in a résumé format including an applicant name, an applicant address, educational history, and work history.

10. The method of claim 9, further comprising scrubbing the résumé content to remove personal data present in the résumé content generated by the AI model prior to displaying the sample résumé.

11. The method of claim 9, further comprising replacing personal information in the résumé content with generic personal information.

12. The method of claim 7, further comprising:
registering the résumé content with a résumé database; and
assigning a document ID to the résumé content.

13. The method of claim 7, wherein the at least one job title and the template selection are provided in a text file containing a plurality of job titles, each associated with a years of experience value and a résumé template name, the text file being structured as a comma-separated-value (CSV) file.

14. A processing system configured to dynamically create a sample résumé, comprising:
one or more computer-readable storage devices storing computer-readable instructions;
one or more processors configured to, when executing the computer-readable instructions, cause the processing system to:
provide, to an external computing system, a user interface configured to accept user inputs and transmit the user inputs to the processing system;
receive at least one job title from the user interface;
generate a prompt including the at least one job title, the prompt being configured to cause an artificial intelligence (AI) model to generate content associated with a résumé;
receive a template selection from a list of available templates displayed in the user interface, each template in the list of available templates represents a graphical design of an output for the sample résumé;
receive résumé content generated by the AI model based on the prompt;
apply the template selection to the résumé content to generate the sample résumé; and
display, in an interactive element of the user interface, the sample résumé, the interactive element being configured to accept edits to the résumé content of the sample résumé.

15. The processing system of claim 14, wherein the one or more processors are further configured to, when executing the computer-readable instructions, cause the processing system to: receive, by way of the interactive element, edits to the résumé content of the sample résumé.

16. The processing system of claim 14, wherein generating the prompt further comprises instructing, by way of the prompt, the AI model to structure the content in a résumé format including an applicant name, an applicant address, educational history, and work history.

17. The processing system of claim 16, wherein the one or more processors are further configured to, when executing the computer-readable instructions, cause the processing system to: scrub the résumé content to remove personal data present in the résumé content generated by the AI model prior to displaying the sample résumé.

18. The processing system of claim 17, wherein the one or more processors are further configured to, when executing the computer-readable instructions, cause the processing system to: replace the personal data in the résumé content with generic personal information.

19. The processing system of claim 16, wherein the one or more processors are further configured to, when executing the computer-readable instructions, cause the processing system to: replacing personal information in the résumé content with generic personal information.

14. The processing system of claim 14, wherein the one or more processors are further configured to, when executing the computer-readable instructions, cause the processing system to:
registering the résumé content with a résumé database; and
assigning a document ID to the résumé content.
